(19) United States
(12) Patent Application Publication
(10) Pub. No.: US 2020/0407558 A1
(43) Pub. Date: Dec. 31, 2020

(54) PES-PPSU BLENDS AS BASIS FOR FOAMS

(71) Applicant: Evonik Operations GmbH, Essen (DE)

(72) Inventors: Christian TRAßL, Warmensteinach (DE); Kay Bernhard, Cheshire, CT (US); Luiz Araujo, Sao José dos Campos, SP (BR); Ina Liebl, Griesheim (DE); Dirk Roosen, Mobile, AL (US); Uwe Lang, Nieste (DE); Thomas Richter, Darmstadt (DE); Marion Hax, Gross-Umstadt (DE); Ron van Hoorn, RZ Deventer (NL)

(73) Assignee: Evonik Operations GmbH, Essen (DE)

(21) Appl. No.: 16/767,240

(22) PCT Filed: Nov. 20, 2018
(86) PCT No.: PCT/EP2018/081841

§ 371 Date: May 27, 2020

(30) Foreign Application Priority Data
Nov. 27, 2017 (EP) 17203685.7

(51) Int. Cl. C08L 81/06; C08J 9/00; C08J 9/14; C08J 9/12; C08J 9/06

(52) U.S. Cl. CPC C08L 81/06; C08J 2481/06; C08J 9/142; C08J 9/141; C08J 9/122; C08J 9/125; C08J 9/06; C08L 2203/14; C08L 2205/025; C08L 2205/03; C08J 2203/10; C08J 2203/06; C08J 2203/16; C08J 2203/14; C08J 2203/12; C08J 2381/06; C08J 9/0061

(57) ABSTRACT

A composition is used for producing novel types of foam in that they combine specifically good flame-retardant properties with a good elongation at break. These novel types of foam are produced from a blend of polyether sulphone (PES) and polyphenylene sulphone (PPSU).

### FIELD OF THE INVENTION

The present invention relates to a composition for producing novel types of foam in that they combine specifically good flame-retardant properties with a good elongation at break. These novel types of foam are produced from a blend of polyether sulphone (PES) and polyphenylene sulphone (PPSU).

### PRIOR ART

PES and PPSU blends for other technical applications are known. EP 1 497 376 describes such a blend for processing in melt fabrication, injection moulding, compression moulding, extrusion or blow moulding. However, it is not known to produce a foam from such a composition.

Porous membranes from such blends have also been described, in EP 0 764 461 for example. Membranes of this type are produced via a casting process from an aqueous composition of polymer.

Many industrially utilized foams either have disadvantages in use at high temperatures or have less than ideal mechanical properties overall, but specifically at these high temperatures. Furthermore, only very few existing foams are not extremely flammable and so qualify for installation in the interiors of road, rail or air vehicles for example. PES foams, for instance, have a poor flame-retardant effect, while PPSU foams, say, have a less than ideal breaking strength.

Foams from PPSU or PES are known in principle, albeit not in admixture with each other. Work to identify ideal conditions for foaming PPSU and/or PES was reported in “Polymeric Foams from High-Performance Thermoplastics”, Advances in Polymer Technology, Vol. 30, No. 3, pp, 234-243, 2011 (001 10.1002/adv) by L. Sorrentino.

Blends comprising either PPSU or PES are similarly known, albeit with rather sparse particulars being provided in the prior art. More particularly, both polymers have been used as a quantitatively minor component, for example in PS foams, in order to influence the properties of these commodity materials. Foams comprising PPSU or PES as the major component, by contrast, are only found in very few descriptions, for example in the following:

U.S. Pat. No. 4,940,733 discloses a foam based on a blend of a polycarbonate with a second polymer comprising PES or PPSU in addition to a multiplicity of other examples. While a foam of this type has a high level of thermal stability, its flame-retardant effect is not particularly good. Nor are any particulars provided regarding mechanical properties.

WO 2015/097058 describes PPSU- or PES-based foams comprising not less than 10 wt % of a polyolefin. The phase-separating polyolefin presumably acts primarily as a nucleating agent. While more uniform cells are obtained, the flame-retardant properties or the mechanical properties, e.g. elongation at break, do not benefit. In fact, phase separation is likely to have an adverse effect on elongation at break. Flame retardancy is also likely to be adversely affected by the admixed polyolefin component.

### PROBLEM

The problem addressed by the present invention in view of the prior art was that of providing a composition for producing novel types of foam. The resulting foams shall evince a good combination of utility at high temperatures, good mechanical properties, particularly as regards elongation at break, and an at least sufficient flame-retardant effect for many applications in vehicle and aircraft construction.

The foam shall more particularly have a sustained-use temperature of up to 120° C., preferably up to 150° C.

It should also be possible for the foam to be realized from the composition to be provided via a very wide variety of methods and in a wide spectrum of forms.

Further non-explicit problems addressed are derivable from the description, the claims or the examples of the present text without having been explicitly recited here for this purpose.

### SOLUTION

The problems are solved by making available a novel type of composition for production of thermally stable low-flammable engineering foams. This composition for production of foams is characterized in that according to the present invention it contains from 60 to 98 wt % of a mixture of PES and PPSU in a ratio between 1:9 and 9:1, preferably between 1:1 and 8.5:1, as main constituent.

This composition further includes from 0.5 to 10 wt % of a blowing agent. It may further contain inter alia from 0 to 10 wt % of additives and from 0 to 20 wt % of a third polymeric component.

The composition more preferably consists of from 90 to 95 wt % of a mixture of PES and PPSU in a ratio between 1:1 and 8:1, from 1 to 9 wt % of a blowing agent and from 1 to 5 wt % of additives.

The additives may comprise in particular flame retardants, plasticizers, pigments, UV stabilizers, nucleating agents, impact modifiers, adhesion promoters, rheology modifiers, chain extenders, fibres and/or nanoparticles.

The flame retardants used are generally phosphorus compounds, in particular phosphates, phosphines or phosphites. Suitable UV stabilizers and/or UV absorbers are common general knowledge in the art. HALS compounds, Tiuvins or triazoles are generally used for this purpose. The impact modifiers used are generally polymer beads comprising an elastomeric and/or soft/flexible phase. These polymer beads frequently comprise core-(shell-)shell beads having an outer shell which, as such, is no more than lightly crosslinked and as purely polymer would exhibit at least minimal miscibility with the PES-PPSU blend. Any known pigments are employable in principle. Major amounts in particular do of course require testing as to their influence on the foaming operation, like all other additives employed in amounts above 0.1 wt %. This is not very burdensome to do for a person skilled in the art.

Suitable plasticizers, rheology modifiers and chain extenders are common general knowledge in the art of producing sheetings, membranes or mouldings from PES, PPSU or blends thereof, and are accordingly transferrable at minimal cost and inconvenience to the production of a foam from the composition according to the present invention.

The fibres are generally known fibrous materials for addition to a polymer composition. In a particularly suitable embodiment of the present invention, the fibres are PES fibres, PPSU fibres or blend fibres, the latter from PES and PPSU.

Nanoparticles, for example in the form of tubes, platelets, rods, spheres or in other known forms, are inorganic materials in general. They may perform various functions in the final foam at one and the same time. This is because these particles act in part as nucleating agents in the foaming operation, The particles can further influence the mechanical properties as well as the (gas) diffusion properties of the foam. The particles further make an additional contribution to low flammability.

The recited nanoparticles aside, microparticles or largely immiscible, phase-separating polymers may also be included as nucleating agents. In the context of nucleating agents in the composition, the polymers described must be viewed separately from the other nucleating agents, since the latter primarily exert influence on the mechanical properties of the foam, on the melt viscosity of the composition and hence on the foaming conditions. The additional effect of a phase-separating polymer as a nucleating agent is an additional desired effect of this component, but not the primary effect in this case. Therefore, these additional polymers appear further up in the overall tally, separate from the other additives.

The additional polymers may comprise for example polyamides, polyolefins, in particular PP, PEEK, polyesters, in particular PET, other sulphur-based polymers, e.g. PSU, polyetherimides or polymethacrylimide.

The choice of blowing agent is relatively free and for a person skilled in the art is dictated in particular by the foaming method chosen and the foaming temperature. Suitable are, for example, alcohols, e.g. isopropanol or butanol, ketones, such as acetone or methyl ethyl ketone, alkanes, such as isobutane, n-butane, isopentane, n-pentane, hexane, heptane or octane, alkenes, e.g. pentene, hexene, heptene or octene, CO₂, N₂, water, ethers, e.g. diethyl ether, aldehydes, e.g. formaldehyde or propanal, hydro(chloro)fluorocarbons, chemical blowing agents or mixtures of two or more thereof.

Chemical blowing agents are relatively or completely involatile substances which undergo chemical decomposition under foaming conditions to form the actual blowing agent upon decomposition. tert-Butanol is a very simple example thereof in that it forms isobutene and water under foaming conditions. Further examples are NaHCO₃, citric acid, citric acid derivatives, azodicarbonamide (ADC) and/or compounds based thereon, toluenesulphonylhydrazine (TSH), oxybis(benzosulphohydroazide) (OBSH) or 5-phenyltetrazole (5-PT).

Preference for use as blowing agents is given to CO₂, N₂ and mixtures thereof.

Not only the composition but naturally also foams produced from the compositions of the present invention also form a constituent part of the present invention.

The present invention further also provides a process for foaming the compositions of the present invention. The composition is foamed therein at a temperature between 150 and 250° C. and at a pressure between 0.1 and 2 bar. Foaming is preferably effected at a temperature between 180 and 230° C. in a standard pressure atmosphere.

Various methods of foaming polymeric compositions are known by a person skilled in the art to be in principle applicable to the present composition particularly in respect of methods for thermoplastic foams. However, there are some particularly preferable alternatives.

In a first preferred version of the process, a composition without blowing agent is admixed with the blowing agent in an autoclave at a temperature between 20 and 120° C. and at a pressure between 30 and 100 bar and subsequently expanded inside the autoclave by reducing the pressure and raising the temperature to the foaming temperature. Alternatively, the composition admixed with the blowing agent is cooled down in the autoclave and deautoclaved after cooling. This composition is then expandable at a later date by heating to the foaming temperature. This may also take place, for example, under further moulding or in combination with other elements such as inserts or facing layers.

In a second version of the process, the composition containing the blowing agent is heated in an extruder.

In a third version of the process, the composition without blowing agent is heated in an extruder and admixed with the blowing agent, preferably with CO₂ and/or N₂ in the extruder.

The manner in which the composition is let out of the extruder in the second or third version subsequently gives rise to further embodiments. Thus, the composition can exit from the extruder via a wide slot die or some other shaping die, expanding as it passes through the die to the outside of the die. This version is combinable with a directly subsequent coextrusion or lamination such that facing layers are directly applied to a foamed sheet or sheeting formed out of a wide slot die.

In a second embodiment of the third or second version, the composition expands on emerging from the extruder and a pelletizer cuts the expanding extrudate into a bead foam. In general, the pelletizer in this embodiment is so close to the point of exit from the die that the beads already separated off expand directly after formation.

In a third embodiment of the second or third version, finally, the composition exiting the extruder may pass into a structural foam moulding apparatus. In this apparatus, expansion then takes place directly with moulding.

A fourth, alternative embodiment is characterized in that the composition emerging from an extruder passes into an underwater pelletizer wherein there is present such a combination of temperature and pressure that foaming is prevented. The pellet material laden with blowing agent that is obtained in this procedure can then be expanded—thermally, for example—later.

The foams according to the invention and/or the foams obtained by the process according to the invention are useful for many purposes. The foams are preferably employed in vehicle construction, e.g. the construction of road, rail, water, space or air vehicles. By virtue of their low flammability, the foams of the present invention can more particularly also be installed in the interior of these vehicles. Further areas of application include, for example, the electrical and electronics industry, the construction of wind power systems and mechanical engineering.

The foams of the present invention preferably have an expansion rate amounting to between 1 and 98%, preferably between 50 and 97%, more preferably between 70 and 95%, reduction in density versus the pure blend. Foam density is preferably between 20 and 1000 kg/m³, preferably 40 and 250 kg/m³.

1. A composition for production of foams, comprising:
from 60 to 98 wt % of a mixture of polyether sulphone (PES) and polyphenylene sulphone (PPSU) in a ratio between 1:9 and 9:1,
0.5 to 10 wt % of a blowing agent,
from 0 to 10 wt % of additives, and
from 0 to 20 wt % of a third polymeric component.

2. The composition according to claim 1, wherein the PES and PPSU are present in a ratio between 1:1 and 8.5:1.

3. The composition according to claim 1, wherein the additives comprise flame-retardants, plasticizers, pigments, UV stabilizers, nucleating agents, impact modifiers, adhesion promoters, rheology modifiers, chain extenders, fibres and/or nanoparticles.

4. The composition according to claim 1, wherein the blowing agent comprises an alcohol, a ketone, an alkane, an alkene, CO₂, N₂, water, an ether, an aldehyde, chemical blowing agents, or mixtures of two or more thereof.

5. The composition Composition according to claim 1, wherein the composition consists of:
from 90 to 95 wt % of the mixture of PES and PPSU in a ratio between 1:1 and 8:1,
from 1 to 9 wt % of the blowing agent, and
from 1 to 5 wt % of the additives.

6. A foam obtained by foaming the composition according to claim 1.

7. A process, comprising:
foaming the composition according to claim 1,
wherein the composition is foamed at a temperature between 150 and 250° C. and at a pressure between 0.1 and 2 bar.

8. The process according to claim 7, wherein the composition is foamed at a temperature between 180 and 230° C. in a standard pressure atmosphere.

9. The process according to claim 7, wherein a composition without the blowing agent is admixed with the blowing agent in an autoclave at a temperature between 20 and 120° C. and at a pressure between 30 and 100 bar, and
subsequently expanded inside the autoclave by reducing the pressure and raising the temperature to the foaming temperature, or
expanded outside the autoclave, following cooling down inside the autoclave and deautoclaving, by heating to the foaming temperature.

10. The process according to claim 7, wherein the composition is heated in an extruder.

11. The process according to claim 7, wherein composition without the blowing agent is both heated and admixed with the blowing agent in an extruder.

12. The process according to claim 10, wherein the composition exits from the extruder via a wide slot die or some other shaping die, expanding as the composition passes through the die to the outside of the die.

13. The process according to claim 10, wherein the composition emerging from the extruder passes into an underwater pelletizer, wherein there is present such a combination of temperature and pressure that foaming is prevented, and wherein a pellet material laden with the blowing agent is obtained which is expanded later.

14. The process according to claim 10, wherein the composition passes from the extruder into a structural foam moulding apparatus and is expanded and moulded therein.
